(19) United States
(12) Patent Application Publication
(10) Pub. No.: US 2013/0207741 A1
(43) Pub. Date: Aug. 15, 2013

(54) PROGRAMMABLE DIRECTIONAL COUPLER

(71) Applicant: Calogero D, Presti, San Diego, CA (US)

(72) Inventor: Calogero D, Presti, San Diego, CA (US)

(73) Assignee: QUALCOMM INCORPORATED, San Diego, CA (US)

(21) Appl. No.: 13/372,048

(22) Filed: Feb. 13, 2012

(51) Int. Cl. H01P 5/12

(52) U.S. Cl. 333/111

(57) ABSTRACT

A programmable directional coupler to detect incident power and possibly reflected power is disclosed. The programmable directional coupler includes first and second inductors and at least one adjustable capacitor. The first inductor is coupled between first and second nodes, and the second inductor is coupled between third and fourth nodes of the programmable directional coupler. The second inductor is magnetically coupled to the first inductor and has a mutual inductance with the first inductor. The at least one adjustable capacitor is coupled between the first and second inductors. The programmable directional coupler may further include at least one fixed or adjustable capacitor coupled between at least one node among the first, second, third and fourth nodes and circuit ground. The programmable directional coupler may further include an adjustable resistor coupled between the fourth node and circuit ground.

### BACKGROUND

I. Field

The present disclosure relates generally to electronics, and more specifically to a directional coupler for a wireless device.

II. Background

A wireless device (e.g., a cellular phone or a smart phone) in a wireless communication system may transmit and receive data for two-way communication. The wireless device may include a transmitter for data transmission and a receiver for data reception. For data transmission, the transmitter may modulate a radio frequency (RF) carrier signal with data to obtain a modulated RF signal, amplify the modulated RF signal to obtain an output RF signal having the proper transmit power level, and transmit the output RF signal via an antenna to a base station. For data reception, the receiver may obtain a received RF signal via the antenna and may condition and process the received RF signal to recover data sent by the base station.

A wireless device may include a directional coupler in a transmitter to detect the transmit power delivered to an antenna. It is desirable to implement the directional coupler to achieve good performance while reducing circuitry.

### BRIEF DESCRIPTION OF THE DRAWINGS

FIG. 1 shows a wireless device communicating with different wireless communication systems.

FIG. 2 shows a block diagram of the wireless device in FIG. 1.

FIGS. 3 and 4 show two exemplary designs of output circuits in a transmitter.

FIGS. 5A to 5D show four exemplary designs of a programmable directional coupler.

FIG. 6 shows performance of a programmable directional coupler.

FIG. 7 shows a wireless device with multiple directional couplers.

FIGS. 8A and 8B show exemplary designs of two inductors.

FIG. 9 shows an exemplary design of an adjustable capacitor.

FIG. 10 shows a process for performing directional coupling.

### DETAILED DESCRIPTION

The detailed description set forth below is intended as a description of exemplary designs of the present disclosure and is not intended to represent the only designs in which the present disclosure can be practiced. The term “exemplary” is used herein to mean “serving as an example, instance, or illustration.” Any design described herein as “exemplary” is not necessarily to be construed as preferred or advantageous over other designs. The detailed description includes specific details for the purpose of providing a thorough understanding of the exemplary designs of the present disclosure. It will be apparent to those skilled in the art that the exemplary designs described herein may be practiced without these specific details. In some instances, well-known structures and devices are shown in block diagram form in order to avoid obscuring the novelty of the exemplary designs presented herein.

A programmable directional coupler suitable for a wireless device is described herein. A directional coupler is a circuit that receives an input signal at a first port, passes most of the input signal to a second port, and couples a portion of the input signal to a third port. A directional coupler may also receive a reflected signal at the second port and couples a portion of the reflected signal to a fourth port. A directional coupler may thus be used to detect incident power and possibly reflected power traveling between one circuit (e.g., a power amplifier) and another circuit (e.g., an antenna). A programmable directional coupler is a directional coupler having at least one adjustable circuit component (e.g., at least one adjustable capacitor) that can be varied to change the characteristics of the directional coupler. A programmable directional coupler may provide better performance than a fixed directional coupler and may also have other desirable characteristics.

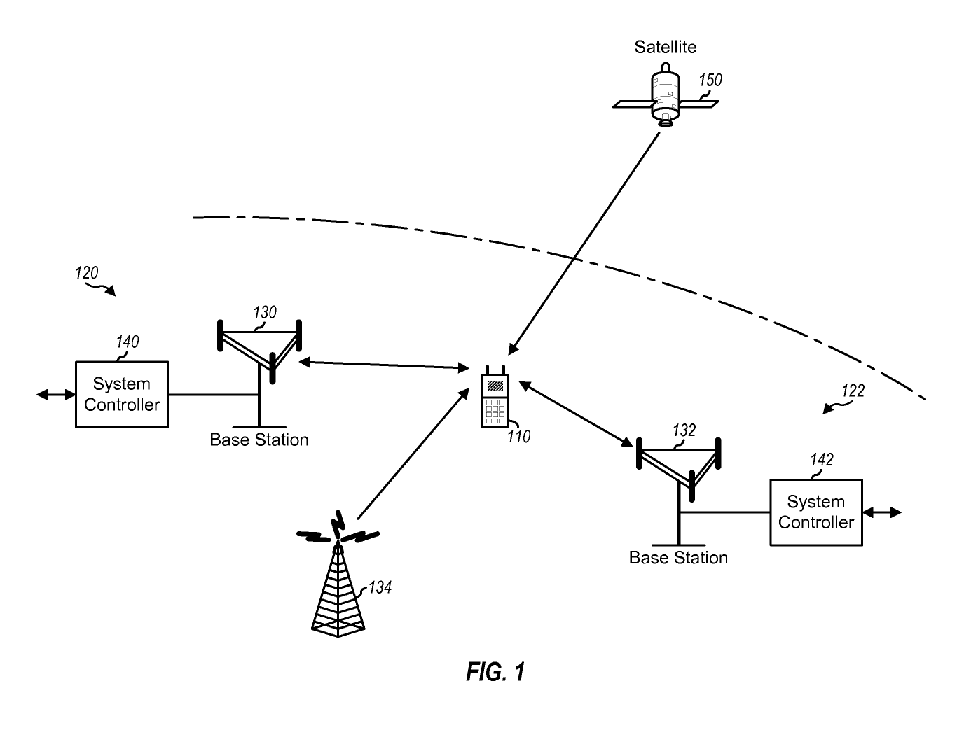

FIG. 1 shows a wireless device 110 capable of communicating with different wireless communication systems 120 and 122. Wireless systems 120 and 122 may each be a Code Division Multiple Access (CDMA) system, a Global System for Mobile Communications (GSM) system, a Long Term Evolution (LTE) system, a wireless local area network (WLAN) system, or some other wireless system. A CDMA system may implement Wideband CDMA (WCDMA), cdma2000, or some other version of CDMA. For simplicity, FIG. 1 shows wireless system 120 including one base station 130 and one system controller 140, and wireless system 122 including one base station 132 and one system controller 142. In general, each wireless system may include any number of base stations and any set of network entities.

Wireless device 110 may also be referred to as a user equipment (UE), a mobile station, a terminal, an access terminal, a subscriber unit, a station, etc. Wireless device 110 may be a cellular phone, a smart phone, a tablet, a wireless modem, a personal digital assistant (PDA), a handheld device, a laptop computer, a smartbook, a netbook, a cordless phone, a wireless local loop (WLL) station, a Bluetooth device, etc. Wireless device 110 may be capable of communicating with wireless system 120 and/or 122. Wireless device 110 may also be capable of receiving signals from broadcast stations (e.g., a broadcast station 134). Wireless device 110 may also be capable of receiving signals from satellites (e.g., a satellite 150) in one or more global navigation satellite systems (GNSS). Wireless device 110 may support one or more radio technologies for wireless communication such as LTE, cdma2000, WCDMA, GSM, IEEE 802.11, etc.

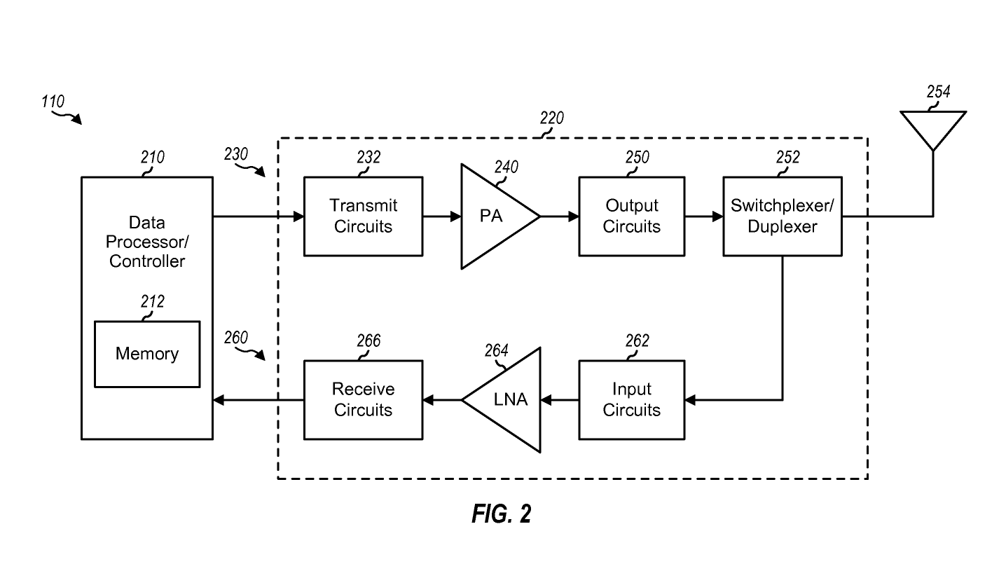

FIG. 2 shows a block diagram of an exemplary design of wireless device 110. In this exemplary design, wireless device 110 includes a data processor/controller 210, a transceiver 220, and an antenna 254. Transceiver 220 includes a transmitter 230 and a receiver 260 that support bi-directional wireless communication.

In the transmit path, data processor 210 processes (e.g., encodes and modulates) data to be transmitted and provides an analog output signal to transmitter 230. Within transmitter 230, transmit circuits 232 amplify, filter, and upconvert the analog output signal from baseband to RF and provide a modulated RF signal. Transmit circuits 232 may include amplifiers, filters, mixers, an oscillator, a local oscillator (LO) generator, a phase locked loop (PLL), etc. A power amplifier (PA) 240 receives and amplifies the modulated RF signal and provides an amplified RF signal having the proper transmit power level. Output circuits 250 receive the amplified RF signal from power amplifier 240 and provide an output RF signal. Output circuits 250 may include a transmit filter, an impedance matching circuit, a programmable directional coupler, etc. The output RF signal is routed through a switchplexer/duplexer 252 and transmitted via antenna 254.

In the receive path, antenna 254 receives signals from base stations and/or other transmitter stations and provides a received RF signal, which is routed through switchplexer/duplexer 252 and provided to receiver 260. Within receiver 260, input circuits 262 process the received RF signal and provide a receiver input signal. Input circuits 262 may include a receive filter, an impedance matching circuit, etc. A low noise amplifier (LNA) 264 amplifies the receiver input signal from input circuits 262 and provides a LNA output signal. Receive circuits 266 amplify, filter, and downconvert the LNA output signal from RF to baseband and provide an analog input signal to data processor 210. Receive circuits 266 may include amplifiers, filters, mixers, an oscillator, a LO generator, a PLL, etc.

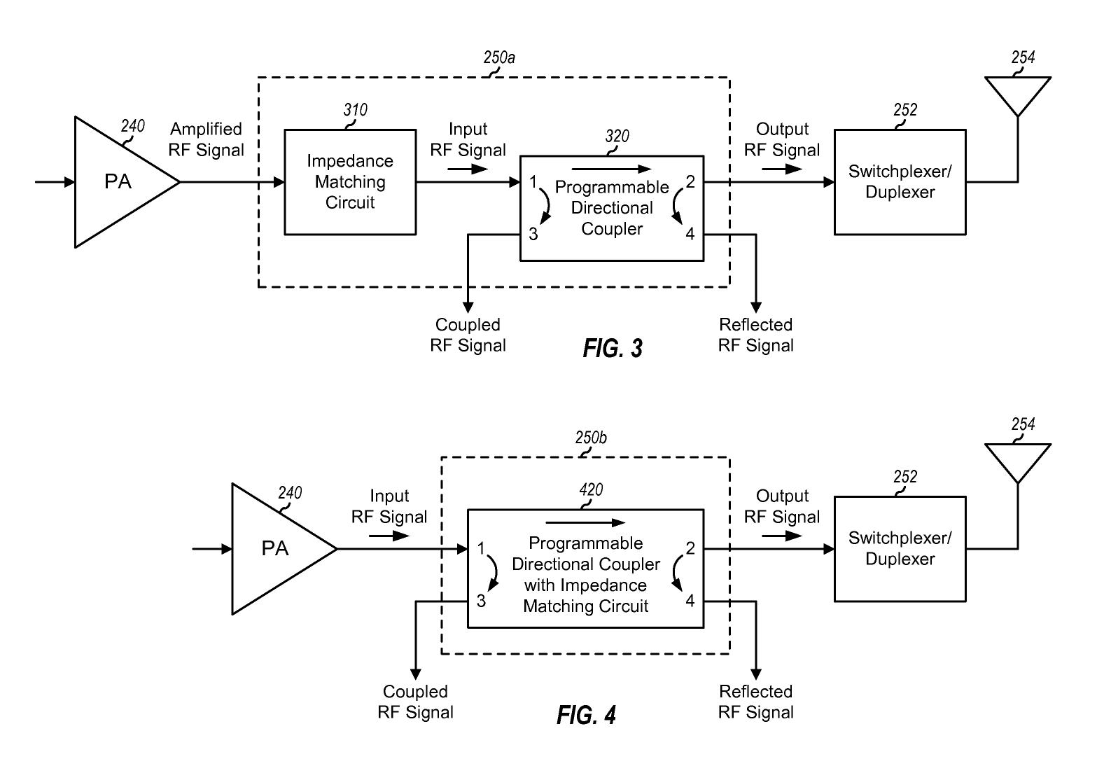

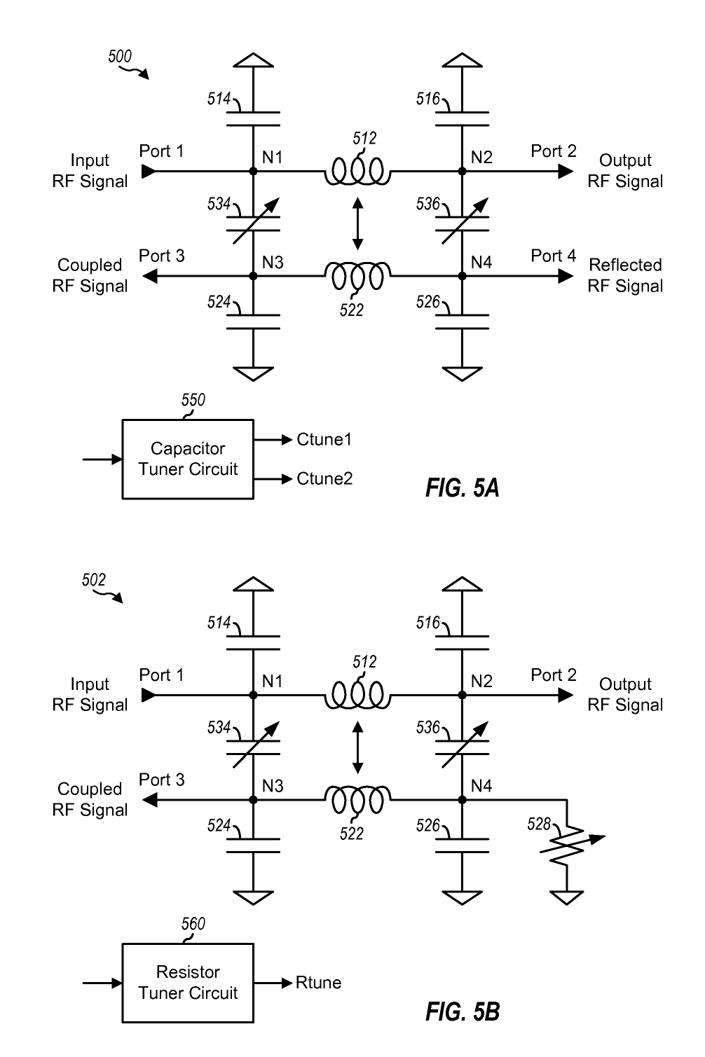

FIG. 2 shows an exemplary design of wireless device 110 with one transmitter 230 and one receiver 260 for one antenna 254. In general, a wireless device may include any number of transmitters and any number of receivers for any number of antennas, any number of frequency bands, and any number of radio technologies. Each transmitter may support operation on one or multiple frequency bands and may include a programmable directional coupler to detect incident power and/or reflected power for that transmitter. A programmable directional coupler may be designed to provide good performance (e.g., sufficient directivity) for all frequency bands supported by the associated transmitter. For example, wireless device 110 may include (i) a first transmitter with a first programmable directional coupler for high band and (ii) a second transmitter with a second programmable directional coupler for low band. Each programmable directional coupler may be coupled in a transmit path between a power amplifier and a switchplexer (e.g., as shown in FIG. 4 below) or between an impedance matching circuit and the switchplexer (e.g., as shown in FIG. 3 below).

FIG. 2 shows an exemplary design of transmitter 230 and receiver 260. Transmitter 230 and/or receiver 260 may include different and/or additional circuits not shown in FIG. 2. For example, transmitter 230 may include a driver amplifier prior to power amplifier 240. All or a portion of transceiver 220 may be implemented on one or more analog integrated circuits (ICs), RF ICs (RFICs), mixed-signal ICs, etc. For example, transmit circuits 232, power amplifier 240, output circuits 250, input circuits 262, LNA 264, and receive circuits 266 may be implemented on an RFIC. Power amplifier 240 and possibly other circuits may also be implemented on a separate IC or circuit module. Output circuits 250 and/or input circuits 262 and possibly other circuits may also be implemented on a separate IC or circuit module.

Data processor/controller 210 may perform various functions for wireless device 110. For example, data processor 210 may perform processing for data being transmitted via transmitter 230 and received via receiver 260. Controller 210 may control the operation of transmit circuits 232, power amplifier 240, output circuits 250, input circuits 262, LNA 264, receive circuits 266, and/or switchplexer/duplexer 252. A memory 212 may store program codes and data for data processor/controller 210. Data processor/controller 210 may be implemented on one or more application specific integrated circuits (ASICs) and/or other ICs.

FIG. 3 shows a block diagram of output circuits 250a, which is one exemplary design of output circuits 250 in FIG. 2. In this exemplary design, output circuits 250a include an impedance matching circuit 310 and a programmable directional coupler 320. Matching circuit 310 performs output impedance matching for power amplifier 240 to transform an input impedance of programmable directional coupler 320 into a load impedance that can provide good performance for power amplifier 240, e.g., improve transmitted power, efficiency, gain, etc. Matching circuit 310 may also include a lowpass filter and/or one or more tunable notch filters to attenuate undesired signals (e.g., at second, third, and/or other harmonic frequencies) from power amplifier 240.

A 3-port programmable directional coupler (not shown in FIG. 3) may be used to detect incident power. The incident power may include mostly the amplified RF signal from power amplifier 240. A 3-port programmable directional coupler has a first/input port denoted as port 1, a second/output port denoted as port 2, and a third/coupled port denoted as port 3. A 3-port programmable directional coupler has its port 1 receiving an input RF signal (e.g., directly or indirectly from a power amplifier), its port 2 providing an output RF signal, and its port 3 providing a coupled RF signal. A 3-port programmable directional coupler couples (i) most of the input RF signal from port 1 to port 2, (ii) a small portion (e.g., an amplitude ratio of approximately 1/10) of the input RF signal from port 1 to port 3, and (iii) a smaller portion (e.g., an amplitude ratio of approximately 1/100 or less) of a reflected RF signal from port 2 to port 3. The reflected RF signal may be due to a load coupled to port 2. For example, a directional coupler may have S(2,1) of approximately −0.1 decibels (dB), S(3,1) of approximately −20 dB, and S(3,2) of approximately −40 dB, where S(y,x) is a transfer function from port x to port y.

A 4-port programmable directional coupler such as programmable directional coupler 320 in FIG. 3 may be used to detect incident power and reflected power. A 4-port programmable directional coupler has a first/input port denoted as port 1, a second/output port denoted as port 2, a third/coupled port denoted as port 3, and a fourth/isolated port denoted as port 4. A 4-port programmable directional coupler has its port 1 receiving an input RF signal (e.g., directly or indirectly from a power amplifier), its port 2 providing an output RF signal, its port 3 providing a coupled RF signal, and its port 4 providing a reflected RF signal. A 4-port programmable directional coupler couples (i) most of the input RF signal from port 1 to port 2, (ii) a small portion (e.g., an amplitude ratio of approximately 1/10) of the input RF signal from port 1 to port 3, (iii) a smaller portion (e.g., an amplitude ratio of approximately 1/100 or less) of the input RF signal to an internal resistor, (iv) a small portion (e.g., an amplitude ratio of approximately 1/10) of a reflected RF signal from port 2 to the internal resistor, and (v) a smaller portion (e.g., an amplitude ratio of approximately 1/100 or less) of the reflected RF signal from port 2 to port 3. For example, a directional coupler may have S(2,1) of approximately −0.1 dB, S(3,1) of approximately −20 dB, S(4,1) of approximately −40 dB, S(3,2) of approximately −40 dB, and S(4,2) of approximately −20 dB.

For both a 3-port and a 4-port programmable directional coupler, port 3 may be coupled to a power detector and possibly a feedback receiver, which are not shown in FIG. 3. The power detector may measure the coupled power at port 3, which may be used to control the operation of transmitter 230 and/or wireless device 110. For example, the measured coupled power may be used for power control to adjust the gain of power amplifier 240 to obtain a desired transmit power level for the output RF signal. The feedback receiver may process the coupled RF signal from port 3 to determine signal fidelity of the input RF signal at port 1, e.g., the amount and quality of distortion introduced by transmitter 230 or power amplifier 240. The amount and quality of distortion sensed by the feedback receiver may be used for perform digital predistortion to improve linearity of transmitter 230.

For a 4-port programmable directional coupler, ports 3 and 4 may be coupled to a power detector and possibly a feedback receiver, which are not shown in FIG. 3. The power detector may measure the coupled power at ports 3 and 4, which may be used to determine an amount of signal reflection due to mismatch at antenna 254.

FIG. 4 shows a block diagram of output circuits 250b, which is another exemplary design of output circuits 250 in FIG. 2. In this exemplary design, output circuits 250b include a programmable directional coupler 420 with an integrated impedance matching circuit. Programmable directional coupler 420 passes most of the power of an input RF signal (which corresponds to an amplified RF signal from power amplifier 240) to switchplexer/duplexer 252. Programmable directional coupler 420 also performs output impedance matching for power amplifier 240.

FIGS. 3 and 4 show two exemplary placements of a programmable directional coupler in a transmitter. A programmable directional coupler may also be included in a transmitter in other manners. For example, a programmable directional coupler may be placed between a switchplexer and an antenna. Certain advantages may be obtained by placing a directional coupler closer to an antenna. For example, placing a directional coupler closer to an antenna may enable self-calibration, improve control of total radiated power, and/or provide other advantages.

In general, a programmable directional coupler may be placed between a power amplifier and a load (e.g., an antenna) and may be used to detect incident power from the power amplifier and possibly reflected power from the load. Most of the incident power from the power amplifier may be delivered to the load, and some of the incident power may be provided as the coupled power. Some of the incident power may be returned as reflected power from the load.

In an exemplary design, a PA module or a PA chip may include a power amplifier and a programmable directional coupler. In another exemplary design, a power amplifier may be included in a PA module or a PA chip, and a programmable directional coupler may be included in a separate circuit module or chip.

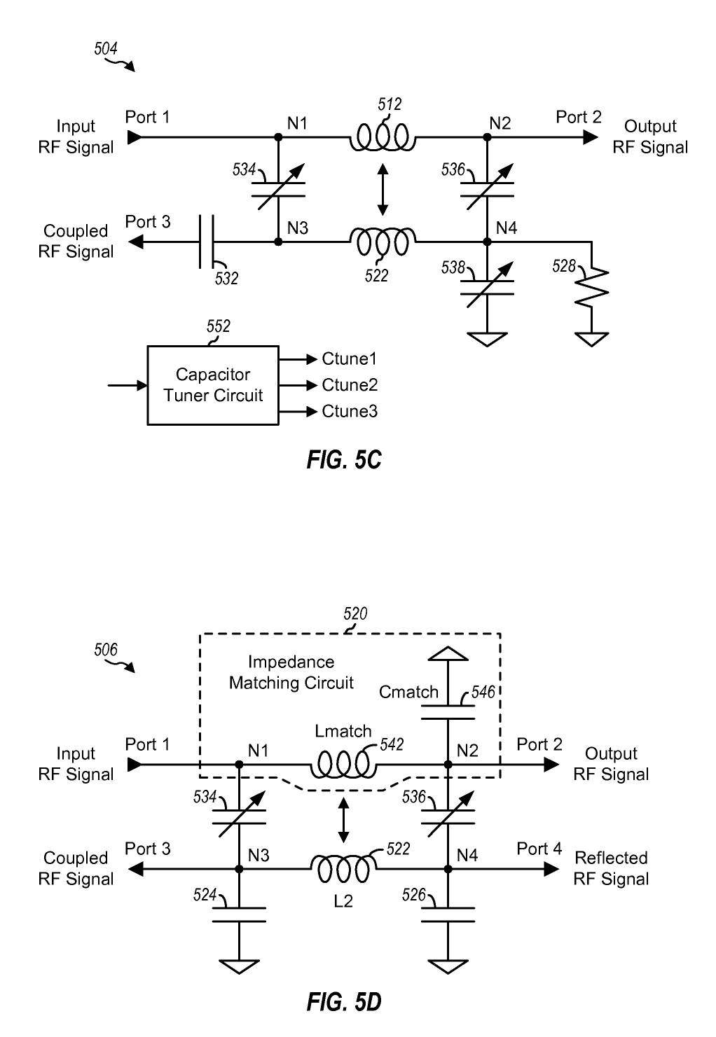

FIG. 5A shows a schematic diagram of an exemplary design of a 4-port programmable directional coupler 500, which may be used for programmable directional coupler 320 in FIG. 3 or programmable directional coupler 420 in FIG. 4. Within programmable directional coupler 500, an inductor 512 is coupled between node N1 and node N2, and an inductor 522 is coupled between node N3 and node N4. A capacitor 514 is coupled between node N1 and circuit ground, and a capacitor 516 is coupled between node N2 and circuit ground. A capacitor 524 is coupled between node N3 and circuit ground, and a capacitor 526 is coupled between node N4 and circuit ground. An adjustable capacitor 534 is coupled between node N1 and node N3, and an adjustable capacitor 536 is coupled between node N2 and node N4. Ports 1, 2, 3 and 4 of programmable directional coupler 500 are coupled to nodes N1, N2, N3 and N4, respectively.

In an exemplary design, a capacitor tuner circuit 550 may receive one or more input parameters and may generate a first capacitor tuning control signal (Ctune1) for adjustable capacitor 534 and a second capacitor tuning control signal (Ctune2) for adjustable capacitor 536. The input parameter(s) may include an operating frequency of power amplifier 240 (i.e., the center frequency of the input RF signal), the transmit power level of the output RF signal, etc.

In the exemplary design shown in FIG. 5A, programmable directional coupler 500 is implemented with two inductors 512 and 522 and six capacitors 514, 516, 524, 526, 534 and 536. In an exemplary design, inductors 512 and 522 may have the same inductance of L. In an exemplary design, capacitors 514, 516, 524 and 526 may have capacitances of Cₑ₁, Cₑ₂, Cₑ₃ and Cₑ₄, respectively, and each may be a fixed capacitor or an adjustable capacitor. In an exemplary design, capacitors 534 and 536 may have capacitances of Cₒ₁ and Cₒ₂, respectively, and each may be a fixed capacitor or an adjustable capacitor. Inductors 512 and 522 and capacitors 514, 516, 524, 526, 534 and 536 may have suitable values selected based on various factors such as a target center frequency of power amplifier 240, a frequency range supported by power amplifier 240, a desired input impedance at port 1, etc.

In an exemplary design that may be used for programmable directional coupler 420 in FIG. 4, capacitors 514 and 516 and inductor 512 may be designed to provide impedance transformation between port 2 and port 1. In another exemplary design that may be used for programmable directional coupler 320 in FIG. 3, capacitors 514 and 516 and inductor 512 may be designed to reduce the reflection coefficient at port 1. In an exemplary design, capacitors 524 and 526, together with inductor 522, may reduce the reflection coefficient at port 3 and port 4, thus improving impedance matching to a power detector, a feedback receiver, and/or other circuits.

Inductor 522 is magnetically coupled with inductor 512. The two inductors 512 and 522 may have a coupling factor of less than one and a mutual inductance of M, which may be a positive or a negative value. A positive mutual inductance means that an induced voltage on inductor 522 is +90° with respect to the current on inductor 512. A negative mutual inductance means that an induced voltage on inductor 522 is −90° with respect to the current on inductor 512. A portion of the input RF signal passing through inductor 512 is coupled to inductor 522 via the magnetically coupling. Inductors 512 and 522 may be implemented on two layers or side-by-side on an IC or a circuit board to reduce space, as described below. In an exemplary design, the mutual inductance M may provide the desired amount of magnetic coupling between inductors 512 and 522, which may determine the amount of incident power at port 1 that is coupled to port 3.

FIG. 5A shows an exemplary design in which two adjustable capacitors 534 and 536 are coupled between inductors 512 and 522 at the two ends. In general, at least one adjustable capacitor may be coupled between the two inductors 512 and 522. Hence, a programmable directional coupler may include only adjustable capacitor 534, or only adjustable capacitor 536, or both adjustable capacitors 534 and 536. Each of adjustable capacitors 534 and 536 may provide electrical coupling between the two inductors 512 and 522.

An important figure of merit of a directional coupler is directivity, which may be expressed in dB as follows:

Directivity=20* log₁₀|S(3,1)|−20* log₁₀|S(3,2)|, Eq (1)

where |S(3,1)| is a ratio of the amplitude of a coupled signal at port 3 to the amplitude of an incident signal at port 1, when the directional coupler is excited at port 1 and no reflection occurs at any port; and
   |S(3,2)| is a ratio of the amplitude of the coupled signal at port 3 to the amplitude of a reflected signal at port 2, when the directional coupler is excited at port 2 and no reflection occurs at any port.

Directivity is a measure of isolation between the ports of a directional coupler. Directivity impacts how much the accuracy of the measurement of the incident power is immune to the reflected power, and vice versa. Directivity should be as high as possible. High directivity depends on cancellation of two signal components and thus requires an accurate balance (e.g., to within a few percent) between the magnetic and electric coupling. Achieving high directivity typically requires accurate electromagnetic modeling of circuit components of the directional coupler as well as parasitic coupling to nearby circuit structures. Achieving high directivity over a wide bandwidth in a small circuit area is challenging for various reasons. For example, it is difficult to adjust the mutual inductance between inductors 512 and 522 and also difficult to predict the mutual inductance.

Adjustable capacitors 534 and/or 536 may be used to increase directivity of programmable directional coupler 500. Capacitor 534 and/or 536 may be adjusted to improve the coupling of an RF signal, e.g., much like tuning a dial in a frequency modulation (FM) radio. The programmability of directional coupler 500 may be used for various purposes such as:
1. Improve directivity even when there are inaccuracies in electro-magnetic modeling of the directional coupler, e.g., when the actual mutual inductance is different from the modeled mutual inductance,
2. Compensate for parasitic coupling to nearby circuit structures,
3. Achieve high directivity over a wider frequency range, and
4. Other purposes.

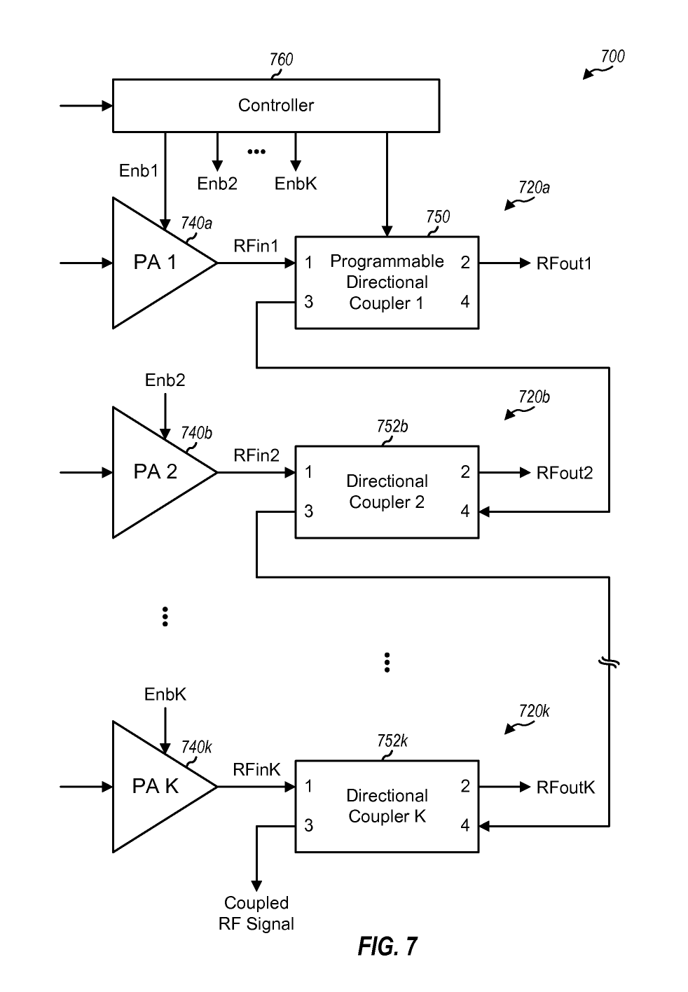

FIG. 5A shows an exemplary design in which a shunt capacitor is coupled between each port/node of programmable directional coupler 500 and circuit ground. In general, one or more shunt capacitors may be connected to one or more ports of programmable directional coupler 500. In an exemplary design, each shunt capacitor is a fixed capacitor having a suitable value, e.g., as shown in FIG. 5A. In another exemplary design, at least one shunt capacitor is adjustable and has a suitable range of values. In any case, the shunt capacitors together with inductor 512 may improve impedance matching for power amplifier 240. Capacitors 514 and 516 and inductor 512 may reduce the bandwidth of the impedance matching, e.g., in case insufficient attenuation is achieved at high frequency with only inductor 512 and capacitor 516. Capacitor 514 may add to the input capacitance of programmable directional coupler 500, which may make programmable directional coupler 500 look like a lowpass filter with a lower cutoff frequency. This lowpass filter may be desired when some attenuation is desired at harmonic frequencies. Capacitors 524 and 526 may improve a S(3,3) and/or S(4,4) transfer function, i.e., the impedance at port 3 and/or port 4. Capacitors 524 and 526 may be especially useful when a good circuit ground is not available on an IC chip and circuit ground has some large parasitic inductance. A better S(3,3) transfer function may improve performance, especially when multiple directional couplers are connected in a daisy chain, e.g., as shown in FIG. 7. The shunt capacitors may provide other advantages.

FIG. 5B shows a schematic diagram of an exemplary design of a 3-port programmable directional coupler 502, which may also be used for programmable directional coupler 320 in FIG. 3 or programmable directional coupler 420 in FIG. 4. Programmable directional coupler 502 includes inductors 512 and 522 and capacitors 514, 516, 524, 526, 534 and 536, which are coupled as described above for FIG. 5A. Programmable directional coupler 502 further includes an adjustable resistor 528 coupled between node N4 and circuit ground. Ports 1, 2 and 3 of programmable directional coupler 502 are coupled to nodes N1, N2 and N3, respectively.

Capacitor tuner circuit 550 (not shown FIG. 5B) may receive one or more input parameters and may generate a Ctune1 control signal for adjustable capacitor 534 and a Ctune2 control signal for adjustable capacitor 536. In an exemplary design, a resistor tuner circuit 560 may receive one or more input parameters and may generate a resistor tuning control signal (Rtune) for adjustable resistor 528. Circuit 560 may vary the resistance of resistor 528 in order to reduce sensitivity to manufacturing process variation and improve the accuracy of the internal termination across manufacturing corners of the resistor. A suitable tuning control signal may be selected by comparing a known accurate resistor to either tunable resistor 528 or another tunable resistor that experiences similar manufacturing process variation. In another exemplary design, a fixed resistor is coupled between node N4 and circuit ground and may have a suitable value.

FIG. 5C shows a schematic diagram of an exemplary design of a 3-port programmable directional coupler 504, which may also be used for programmable directional coupler 320 in FIG. 3 or programmable directional coupler 420 in FIG. 4. Programmable directional coupler 504 includes inductors 512 and 522, capacitors 534 and 536, and resistor 528, which are coupled as described above for FIG. 5B. Programmable directional coupler 504 further includes (i) an alternating current (AC) coupling capacitor 532 coupled between node N3 and port 3 and (ii) an adjustable capacitor 538 coupled between node N4 and circuit ground. Ports 1, 2 and 3 of programmable directional coupler 504 are coupled to nodes N1, N2 and N3, respectively.

In an exemplary design, a capacitor tuner circuit 552 may receive one or more input parameters and may generate a Ctune1 signal for adjustable capacitor 534, a Ctune2 signal for adjustable capacitor 536, and a third capacitor tuning control signal (Ctune3) for adjustable capacitor 538.

Programmable directional coupler 504 in FIG. 5C includes only one shunt capacitor 538 coupled between node N4 and circuit ground, and this capacitor is adjustable. One or more additional shunt capacitors may also be coupled to one or more other nodes, and each additional shunt capacitor may be fixed or adjustable.

FIG. 5D shows a schematic diagram of an exemplary design of a 4-port programmable directional coupler 506, which may also be used for programmable directional coupler 320 in FIG. 3 or programmable directional coupler 420 in FIG. 4. Programmable directional coupler 506 includes inductor 522 and capacitors 524, 526, 534 and 536, which are coupled as described above for FIG. 5A. Programmable directional coupler 506 further includes (i) an inductor 542 coupled between node N1 and node N2 and (ii) a capacitor 546 coupled between node N2 and circuit ground. Inductors 522 and 542 are magnetically coupled and have a mutual inductance of M, which may be a positive or a negative value. Inductor 522 has an inductance of L2, and inductor 542 has an inductance of Lmatch. Capacitor 546 has a capacitance of Cmatch. Ports 1, 2, 3 and 4 of programmable directional coupler 506 are coupled to nodes N1, N2, N3 and N4, respectively.

Capacitor tuner circuit 550 (not shown FIG. 5D) may receive one or more input parameters and may generate a Ctune1 control signal for adjustable capacitor 534 and a Ctune2 control signal for adjustable capacitor 536.

As shown in FIG. 5D, programmable directional coupler 506 includes an embedded impedance matching circuit 520 formed by inductor 542 and capacitor 546. Inductor 542 is used for a programmable directional coupler and is also reused for an impedance matching circuit.

FIGS. 5A to 5D show four exemplary designs of a programmable directional coupler. In general, a programmable directional coupler may include two coupled inductors (e.g., inductors 512 and 522) and at least one adjustable capacitor (e.g., capacitor 534 and/or 536) coupled between these two inductors. The two coupled inductors may have the same inductance or different inductances. A programmable directional coupler may also include one or more shunt capacitors (e.g., capacitor 514, 516, 524 and/or 526) coupled between one or more nodes and circuit ground. Each shunt capacitor may be a fixed capacitor (e.g., as shown in FIGS. 5A, 5B and 5D) or an adjustable capacitor (e.g., as shown in FIG. 5C). A programmable directional coupler may include an internal termination resistor (e.g., resistor 528 in FIG. 5B and 5C) or may omit this resistor. A switchplexer comprising one or more switches may be coupled to port 2 of a programmable directional coupler.

FIGS. 5A to 5D show exemplary designs of programmable directional couplers 500 to 506 having one section. A programmable directional coupler may also include multiple sections to achieve a higher order transfer function and obtain a wider bandwidth. Each section may include two coupled inductors and at least one adjustable capacitor coupled between the inductors.

In the exemplary designs shown in FIGS. 5A to 5D, high directivity of a programmable directional coupler (and also matching of all ports of the programmable directional coupler) may be obtained if the following conditions are satisfied:

Zₑᵥₑₙ*Z_{odd}=Z₀², and Eq (2)

αₑᵥₑₙ*L=α_{odd}*L, Eq (3)

where Zₑᵥₑₙ and Z_{odd} are the impedance at a port of the programmable directional coupler for an even mode and an odd mode, respectively,
Z₀ is a characteristic impedance, which may be 50 Ohms, 75 Ohms, etc., and
αₑᵥₑₙ and α_{odd} are electrical phase shifts for the even and odd modes, respectively.

Zₑᵥₑₙ may be dependent on the ratio of the inductances of inductors 512 and 522 (increased by the mutual inductance M) and the capacitances of capacitors 514, 516, 524 and 526. Z_{odd} may be dependent on the ratio of the inductances of inductors 512 and 522 (decreased by the mutual inductance M) and the capacitances of capacitors 514, 516, 524, 526, 534 and 536. αₑᵥₑₙ may be dependent on the product between the inductances of inductors 512 and 522 (increased by the mutual inductance M) and the capacitances of capacitors 514, 516, 524 and 526. α_{odd} may be dependent on the product between the inductances of inductors 512 and 522 (decreased by the mutual inductance M) and the capacitances of capacitors 514, 516, 524, 526, 534 and 536.

To obtain coupled power at port 3, Zₑᵥₑₙ is typically larger than Z_{odd}. Magnetic coupling between inductors 512 and 522 increases the ratio of Zₑᵥₑₙ to Z_{odd}. Also, capacitors 534 and 536 increase the ratio of Zₑᵥₑₙ to Z_{odd}. Hence, with appropriate inductance, mutual inductance, and capacitance values, the ratio of Zₑᵥₑₙ to Z_{odd} may be skewed larger to obtain higher coupling while maintaining the product constant in order to satisfy equations (2) and (3).

In an exemplary design, the inductances of inductors 512 and 522 and the capacitances of capacitors 514, 516, 524, 526, 534 and 536 may be determined as follows:

$$\begin{matrix}{Z}_{even} / {Z}_{odd} = 1.222 \{ t \} , & Eq ( 4 ) \\ {Z}_{even} = \sqrt{{Z}_{0}^{2} * {Z}_{even} / {Z}_{odd}} , & Eq ( 5 ) \\ {Z}_{odd} = \sqrt{\frac{{Z}_{0}^{2}}{{Z}_{even} / {Z}_{odd}}} , & Eq ( 6 ) \\ L = \frac{{Z}_{even} + {Z}_{odd}}{4 π * {f}_{s}} , & Eq ( 7 ) \\ M = \frac{{Z}_{even} - {Z}_{odd}}{4 π * {f}_{s}} , & Eq ( 8 ) \\ {C}_{e} = \frac{L + M}{{Z}_{even}^{2}} , and & Eq ( 9 ) \\ {C}_{o} = \frac{1}{2} * ( \frac{L - M}{{Z}_{odd}^{2}} - {C}_{e} ) , & Eq ( 10 )\end{matrix}$$

where M is the mutual inductance of inductors 512 and 522,

Cₑ is the capacitance of each of capacitors 514, 516, 524 and 526,

Cₒ is the capacitance of each of capacitors 534 and 536, and

f_{S} is a center frequency of the input RF signal.

An exact solution exists for equations (4) to (10) for any given frequency fₛ. Hence, the values of Cₑ and Cₒ that can provide the best performance may be determined, e.g., via computer simulation, lab measurements, etc.

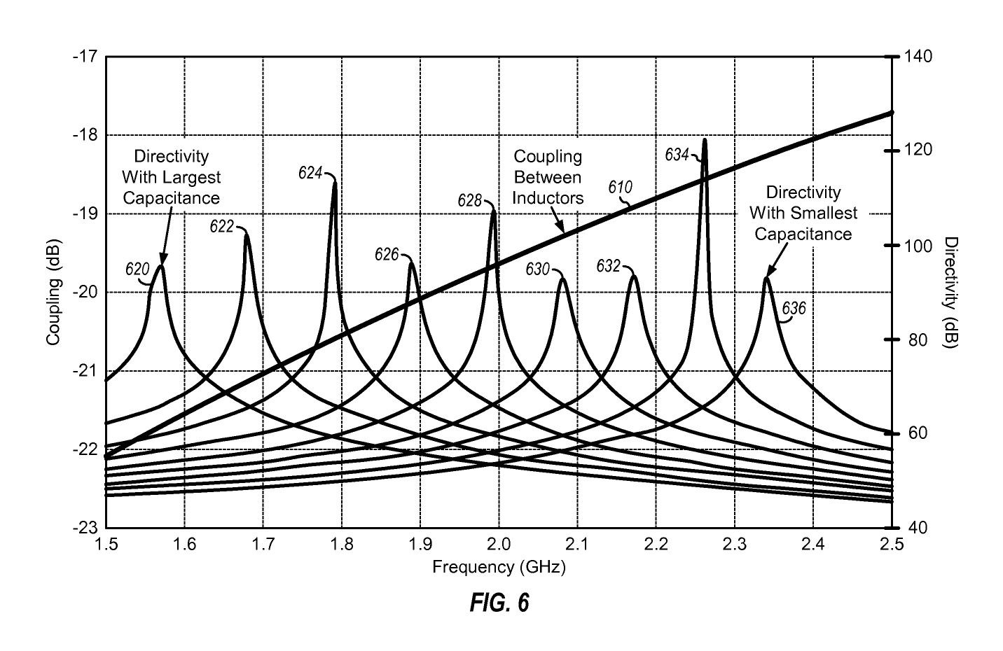

FIG. 6 shows the performance of a programmable directional coupler, which may be any one of the programmable directional couplers in FIGS. 5A to 5D. In FIG. 6, the horizontal axis represents frequency and is given in units of giga-Hertz (GHz). The left vertical axis represents the coupling between the two inductors of the programmable directional coupler and is given in units of dB. A plot 610 shows the coupling between the two inductors of the programmable directional coupler versus frequency.

The right vertical axis in FIG. 6 represents directivity of the programmable directional coupler and is given in units of dB. Plots 620 to 636 show the directivity of the programmable directional coupler for progressively smaller values of capacitors 534 and 536. As shown in FIG. 6, high directivity may be achieved across frequency by adjusting capacitors 534 and 536.

Capacitors 534 and 536 may be adjusted to correct for poorly modeled parasitic coupling, which may mitigate the need for tweaking/trimming/additional fabrication cycles of a circuit module containing the programmable directional coupler. Capacitors 534 and 536 may also be adjusted to correct for parasitic coupling that changes as a result of switchable connections in wireless device 110. For example, power amplifier 240 may selectively drive different outputs via switches in switchplexer 252. Each output may be routed via a different routing trace and may experience different parasitic coupling to the programmable directional coupler. Capacitors 534 and 536 may be adjusted to account for the parasitic coupling between the programmable directional coupler and the routing traces in order to obtain high directivity.

In another aspect of the disclosure, multiple directional couplers for multiple transmitters may be coupled in series in a daisy chain. The multiple directional couplers may include at least one programmable directional coupler. The daisy chain connection may enable the at least one programmable directional coupler to be reused for one or more transmitters.

FIG. 7 shows an exemplary design of a wireless device 700 with multiple directional couplers connected in a daisy chain. In this exemplary design, wireless device 700 includes K transmitters 720a to 720k, where K may be any integer value greater than one.

In the exemplary design shown in FIG. 7, the first transmitter 720a includes a power amplifier 740a and a programmable directional coupler 750. Power amplifier 740a receives a first modulated RF signal and provides a first input RF signal (RFin1). Programmable directional coupler 750 has its port 1 coupled to the output of power amplifier 740a, its port 2 providing a first output RF signal (RFout1), and its port 3 coupled to port 4 of a directional coupler 752b in the second transmitter 720b.

Transmitter 720b includes a power amplifier 740b and directional coupler 752b. Power amplifier 740b receives a second modulated RF signal and provides a second input RF signal (RFin2). Directional coupler 752b has its port 1 coupled to the output of power amplifier 740b, its port 2 providing a second output RF signal (RFout2), its port 3 coupled to port 4 of a directional coupler in the next transmitter (not shown in FIG. 7), and its port 4 coupled to port 3 of programmable directional coupler 750 in the prior transmitter 720a. Each subsequent transmitter 720 includes a power amplifier 740 and a directional coupler 752, which are coupled in similar manner as power amplifier 740b and directional coupler 752b in transmitter 720b.

In the exemplary design shown in FIG. 7, directional couplers 750 and 752 are arranged in a sequential order, and port 3 of the directional coupler in one transmitter is coupled to port 4 of the directional coupler in the next transmitter in the sequential order. Port 3 of directional coupler 752k in the last transmitter 720k may provide a coupled RF signal and may be coupled to a power detector and/or a feedback receiver.

In the exemplary design shown in FIG. 7, only the first transmitter 720a includes a programmable directional coupler 750, and each of the remaining transmitters 720b to 720k includes a fixed directional coupler 752. Programmable directional coupler 750 may be implemented based on any one of the exemplary designs shown in FIGS. 5A to 5D or based on some other circuit design. Programmable directional coupler 750 may include a termination resistor coupled between its port 4 and circuit ground (e.g., in similar manner as resistor 528 in FIG. 5B). Each directional coupler 752 may be implemented based on any of the exemplary designs shown in FIGS. 5A to 5D, albeit with fixed or no capacitors coupled between the two inductors 512 and 522 (instead of adjustable capacitors 534 and 536). Each directional coupler 752 may also be implemented based on some other circuit design.

A controller 760 may receive one or more input parameters and may generate K enable signals for the K power amplifiers 740a to 740k and one or more control signals for programmable directional coupler 750. The input parameters may include or indicate a selected power amplifier among the K power amplifiers 740a to 740k, an operating frequency, a transmit power level, etc. The enable signal for each power amplifier 740 may turn on the power amplifier when it is selected for use or turn off the power amplifier when it is not selected for use. The control signal(s) for programmable directional coupler 750 may vary one or more adjustable capacitors (e.g., any of the adjustable capacitors in FIGS. 5A to 5D). A control signal for programmable directional coupler 750 may also vary a termination resistor coupled between port 4 and circuit ground (e.g., in similar manner as resistor 528 in FIG. 5B).

In the exemplary design shown in FIG. 7, programmable directional coupler 750 is connected to port 4 of at least one other directional coupler 752 in a daisy chain configuration. The capacitors (e.g., capacitors 514, 516, 524, 526, 534 and/or 536) and the termination resistor (e.g., resistor 528) in programmable directional coupler 750 may be adjusted based on which power amplifier among the K power amplifier 740a to 740k is selected for use. When power amplifier 740a in the first transmitter 720a is selected for use, programmable directional coupler 750 may be adjusted to provide good directivity and accurate detection of the incident power from power amplifier 740a. When any one of the remaining power amplifiers 740b to 740k is selected for use, programmable directional coupler 750 may be adjusted to provide a desired impedance at port 3 of programmable directional coupler 750, so that a desired termination impedance can be obtained at port 4 of a directional coupler 752 coupled to the selected power amplifier 740. This may then improve the directivity of the directional coupler 752 coupled to the selected power amplifier 740. In an exemplary design, programmable directional coupler 750 may be adjusted in different manners for different selected power amplifiers.

FIG. 7 shows an exemplary design with a single programmable directional coupler 750 for K power amplifiers 740a to 740k. In another exemplary design, multiple programmable directional couplers may be used for the K power amplifiers 740a to 740k. For example, each power amplifier 740 (instead of only the first power amplifier 740a) may be connected to a programmable directional coupler. As another example, every L-th power amplifier may be connected to a programmable directional coupler, and each remaining power amplifier may be connected to a fixed directional coupler, where L may be any integer value. Multiple programmable and/or fixed directional couplers may also be connected in a daisy chain in other manners.

A programmable directional coupler may be adjusted in various manners. In one exemplary design, the programmable directional coupler may be adjusted based on pre-characterization of the programmable directional coupler. For example, the performance (e.g., the directivity, coupling, etc.) of the programmable directional coupler may be characterized (e.g., during the circuit design phase or the manufacturing phase) for different possible settings of the programmable directional coupler, which may correspond to different values of the adjustable capacitors and/or the termination resistor within the programmable directional coupler. The pre-characterization may be performed for different operating scenarios, which may correspond to different frequencies of interest, different selected power amplifiers if multiple power amplifiers are present (e.g., as shown in FIG. 7), different transmit power levels, etc. The setting of the programmable directional coupler that can provide the best performance for each operating scenario may be stored in a look-up table (e.g., in memory 212 in FIG. 2). The characterization may be performed by computer simulation, lab measurements, factory measurements, field measurements, etc. Thereafter, the setting of the programmable directional coupler that can provide good performance for the current operating scenario may be retrieved from the look-up table and applied to the programmable directional coupler.

In another exemplary design, a programmable directional coupler may be dynamically adjusted, e.g., during operation. For example, one or more parameters such as signal power may be measured for different possible settings of the programmable directional coupler. The setting that can provide the best performance, as measured by the one or more parameters, may be selected for use.

In yet another exemplary design, a programmable directional coupler may be adjusted based on a combination of pre-characterization of the programmable directional coupler and dynamic adjustment. For example, the performance of the programmable directional coupler may be pre-characterized, and the setting that can provide good performance for the current operating scenario may be retrieved from the look-up table and applied to the programmable directional coupler. The programmable directional coupler may then be dynamically adjusted (e.g., within a more narrow range around a nominal value corresponding to the selected setting) during operation.

A programmable directional coupler may also be adjusted in other manners. In any case, the programmable directional coupler may include a plurality of settings. Each setting may correspond to a different set of values for all adjustable capacitors and termination resistor in the programmable directional coupler. A suitable setting of the programmable directional coupler may be selected based on the current operating scenario of the wireless device.

A programmable directional coupler may include two coupled inductors, e.g., as shown in FIGS. 5A to 5D. The two inductors may be implemented in various manners to obtain the desired inductance and coupling. In one exemplary design, the inductors may be implemented with two coupled transmission lines. Various characteristics of the transmission lines (e.g., length, width, spacing, etc.) may be selected based on a target operating frequency and a target bandwidth of the directional coupler. The two inductors may be fabricated on one or more conductive layers of an IC, a circuit board, etc. In another exemplary design, the inductors may be implemented with lumped circuit components (e.g., coupled inductors).

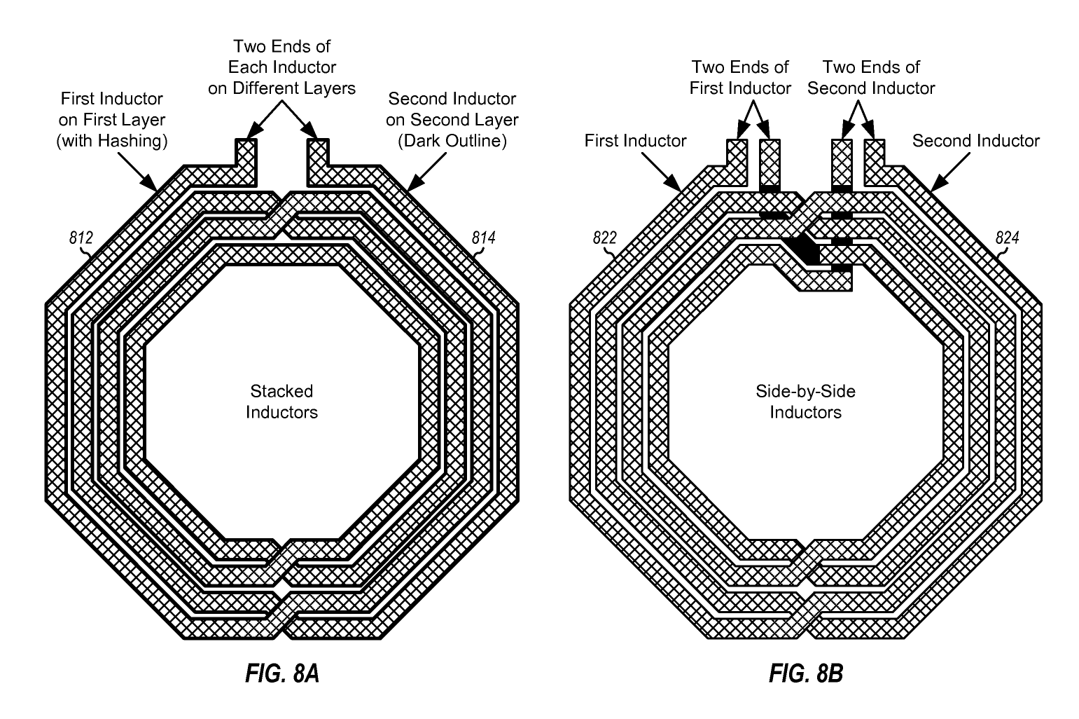

FIG. 8A shows a top view of an exemplary design of two stacked inductors 812 and 814, which may be used in a programmable directional coupler. In this exemplary design, inductors 812 and 814 are fabricated on two conductive layers, e.g., of an RFIC or a circuit module. Inductor 812 is implemented with a first conductor arranged in a spiral pattern on a first conductive layer. Inductor 814 is implemented with a second conductor arranged in a spiral pattern on a second conductive layer. The conductor for inductor 814 overlaps the conductor for inductor 812. Inductor 812 is shown with cross hashing, and inductor 814 is shown with dark outline in FIG. 8A.

FIG. 8B shows a top view of an exemplary design of two side-by-side inductors 822 and 824, which may also be used in a programmable directional coupler. In this exemplary design, inductors 822 and 824 are fabricated on a single conductive layer, e.g., of an RFIC or a circuit module. Inductor 822 is implemented with a first conductor arranged in a spiral pattern on a conductive layer. Inductor 824 is implemented with a second conductor arranged in a spiral pattern on the same conductive layer. The second conductor for inductor 824 is interlaced or interwoven with the first conductor for inductor 822, as shown in FIG. 8B.

FIGS. 8A and 8B show exemplary designs of two inductors for a programmable directional coupler. The stacked topology in FIG. 8A may allow two inductors to be fabricated in a smaller area and may also result in better matching between the two ends of each inductor. The side-by-side topology in FIG. 8B may be used when there is a limited number of metal layers. In general, two inductors in a programmable directional coupler may each be implemented with any number of turns. The two inductors may have the same or different numbers of turns. The number of turns, the diameter of the turns, the width and height of each conductor, the spacing between the two conductors for the two inductors, and/or other attributes of the two conductors may be selected to obtain the desired inductance and quality factor (Q) for each inductor as well as the desired coupling and mutual inductance between the two inductors. The desired coupling and mutual inductance may be obtained by proper placement of the two conductors and/or selecting the proper distance between the conductors.

FIGS. 8A and 8B show exemplary designs in which two inductors are implemented with spiral patterns. Two inductors may also be implemented in other manners such as with a double spiral, zig-zag, or some other pattern. Two inductors may also be fabricated with various conductive materials such as a low-loss metal (e.g., copper), a more lossy metal (e.g., aluminum), or some other material. Higher Q may be achieved for an inductor fabricated on a low-loss metal layer. A smaller-size inductor may be fabricated on a lossy metal layer because different IC design rules may apply.

An adjustable capacitor in a programmable directional coupler may be implemented in various manners. In an exemplary design, an adjustable capacitor may be implemented with a variable capacitor (varactor) having a capacitance that can be adjusted based on an analog control voltage. In another exemplary design, an adjustable capacitor may be implemented with a set of capacitors, each of which may be selected or unselected to change capacitance. In any case, an adjustable capacitor of a programmable directional coupler may be varied to obtain good performance, e.g., high directivity.

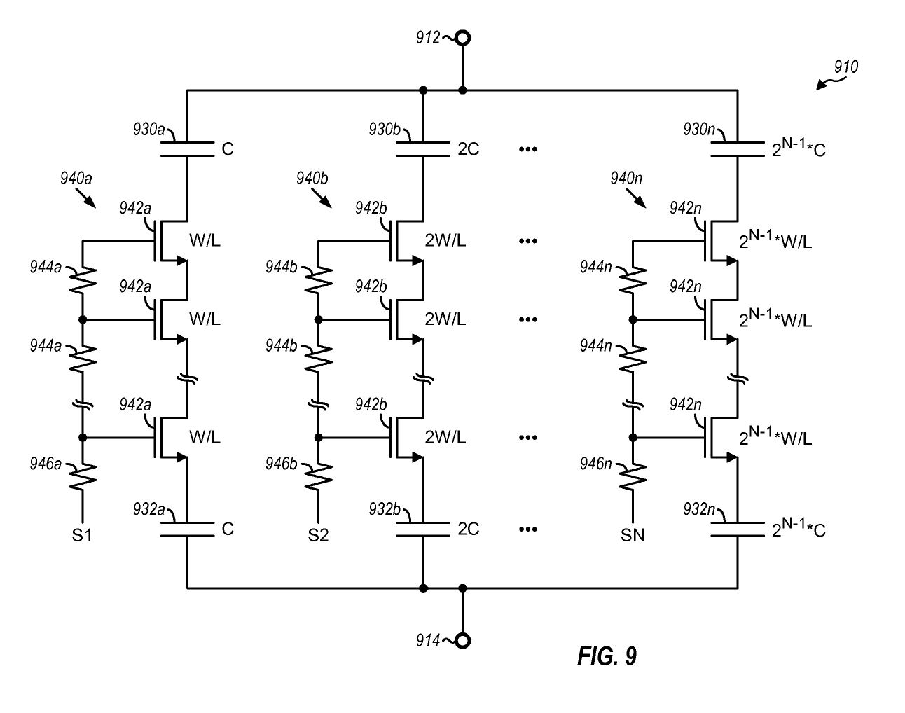

FIG. 9 shows a schematic diagram of an exemplary design of an adjustable capacitor 910 implemented with switchable capacitors. Adjustable capacitor 910 may be used for any of the adjustable capacitors in FIGS. 5A to 5D. In the exemplary design shown in FIG. 9, adjustable capacitor 910 is implemented with N pairs of switchable capacitors, where N may be any value. Each pair of switchable capacitors includes capacitors 930 and 932 coupled in series with an associated high-power switch 940. High-power switch 940 is implemented with multiple N-channel metal oxide semiconductor (NMOS) transistors 942 coupled in a stack. The stack of NMOS transistors 942 can distribute a large signal swing of the input RF signal so that each NMOS transistor can observe only a fraction of the large signal swing. A resistor 944 is coupled between the gates of consecutive NMOS transistors 942 in the stack. A resistor 946 has one end coupled to the gate of the bottommost NMOS transistor in the stack and the other end receiving a control signal for the associated switch 940.

In the exemplary design shown in FIG. 9, N switchable capacitors 930a to 930n have one end coupled to a first terminal 912 and the other end coupled to one end of switches 940a to 940n, respectively. N switchable capacitors 932a to 932n have one end coupled to a second terminal 914 and the other end coupled to the other end of switches 940a to 940n, respectively. The first terminal 912 may correspond to port 1 of a programmable directional coupler and may receive an input RF signal from a power amplifier. The second terminal 914 may correspond to port 3 of the programmable directional coupler and may provide a coupled RF signal. Switches 940a to 940n receive N control signals S1 to SN, respectively. Each switch 940 may be opened or closed based on its associated control signal, which may be applied to a low-voltage end of the stack of NMOS transistors for that switch.

In one exemplary design, the N capacitors 930a to 930n (and also the N capacitors 932a to 932n) may have different capacitances, e.g., of C, 2C, 4C, etc., where C is a base unit of capacitance. In another exemplary design, the N capacitors 930a to 930n (and also the N capacitors 932a to 932n) may have the same capacitance of C.

NMOS transistors 942 used to implement switches 940 coupled to switchable capacitors 930 and 932 may be designed with appropriate transistor sizes to provide good Q across all capacitors. In the exemplary design shown in FIG. 9, NMOS transistors 942 have sizes that are proportional to the sizes of their associated capacitors 930 and 932. Hence, NMOS transistors 942a for switch 940a (which is coupled to capacitors 930a and 932a each having a capacitance of C) may each have a transistor size of W/L, where W is the width and L is the length of an NMOS transistor. NMOS transistors 942b for switch 940b (which is coupled to capacitors 930b and 932b each having a capacitance of 2C) may each have a transistor size of 2 W/L. NMOS transistors 942 for remaining switches 940 may similarly have sizes determined based on the capacitances of their associated capacitors 930 and 932 in order to obtain a target Q for the capacitors.

An adjustable capacitor may be designed to have a suitable tuning range of capacitance values. In an exemplary design with N=4 in FIG. 9, adjustable capacitor 910 may be designed to have a tuning range of approximately C to 15C, which may be larger than a typical tuning range of 2. A large tuning range may enable the programmable directional coupler to be tuned over a wider frequency range. The large tuning range may better address parasitic capacitance, which may be present in addition to an adjustable capacitor. A fixed capacitor may be added to an adjustable capacitor to provide a certain minimum capacitance and/or to reduce the tuning range.

A programmable directional coupler described herein may provide various advantages. The programmable directional coupler may achieve high directivity and low insertion loss in a small circuit area. The programmable directional coupler may also support a wider frequency range. The programmable directional coupler may also have lower cost and/or other advantages.

In an exemplary design, an apparatus (e.g., a wireless device, an IC, a circuit module, etc.) may comprise a programmable directional coupler to detect incident power and possibly reflected power. The programmable directional coupler may comprise first and second inductors and at least one adjustable capacitor. The first inductor (e.g., inductor 512 in FIG. 5A) may be coupled between a first node and a second node of the programmable directional coupler. The second inductor (e.g., inductor 522 in FIG. 5A) may be coupled between a third node and a fourth node of the programmable directional coupler. The second inductor may be magnetically coupled to the first inductor and may have a mutual inductance with the first inductor. The at least one adjustable capacitor (e.g., capacitor 534 and/or 536 in FIG. 5A) may be coupled between the first and second inductors.

In an exemplary design, the programmable directional coupler may be a 3-port programmable directional coupler and may comprise first, second and third ports. The first port may be coupled to the first node and may receive an input RF signal. The second port may be coupled to the second node and may provide an output RF signal. The third port may be coupled to the third node and may provide a coupled RF signal. In another exemplary design, the programmable directional coupler may be a 4-port programmable directional coupler and may further comprise a fourth port. The fourth port may be coupled to the fourth node and may provide a reflected RF signal.

In an exemplary design, the at least one adjustable capacitor may comprise an adjustable capacitor coupled between the first and third nodes or between the second and fourth nodes. In another exemplary design, the at least one adjustable capacitor may comprise (i) a first adjustable capacitor (e.g., capacitor 534) coupled between the first and third nodes and (ii) a second adjustable capacitor (e.g., capacitor 536) coupled between the second and fourth nodes.

In an exemplary design, the programmable directional coupler may further comprise at least one capacitor coupled between at least one node among the first, second, third and fourth nodes and circuit ground. Each of the at least one capacitor may be a fixed capacitor (e.g., as shown in FIG. 5A) or an adjustable capacitor (e.g., as shown in FIG. 5D). In an exemplary design, the programmable directional coupler may further comprise an adjustable resistor (e.g., resistor 528 in FIG. 5B) coupled between the fourth node and circuit ground.

In an exemplary design, the programmable directional coupler may further comprise a capacitor (e.g., capacitor 546 in FIG. 5D) coupled between the second node and circuit ground. The first inductor and the capacitor may form an impedance matching circuit, e.g., as shown in FIG. 5D. The impedance matching circuit may also comprise additional circuit components such as a capacitor coupled between the first node and circuit ground.

In an exemplary design, the first and second inductors may have the same inductance. In another exemplary design, the first inductor may have a first inductance, and the second inductor may have a second inductance that is different from the first inductance, e.g., as shown in FIG. 5D.

In an exemplary design, the first and second inductors may be stacked on two layers of an IC or a circuit board, e.g., as shown in FIG. 8A. In another exemplary design, the first and second inductors may be formed side-by-side on a single layer of the IC or the circuit board, e.g., as shown in FIG. 8B.

In an exemplary design, the at least one adjustable capacitor may include an adjustable capacitor comprising at least one switchable capacitor (e.g., capacitors 830 and/or 832 in FIG. 9). Each switchable capacitor may be selected or unselected based on a respective control signal for that switchable capacitor. In another exemplary design, the at least one adjustable capacitor may include an adjustable capacitor comprising (i) at least one first capacitor (e.g., capacitors 930a and 932a in FIG. 9) each having a first capacitance, (ii) a first set of transistors (e.g., NMOS transistors 942a) coupled to the at least one first capacitor and having a first transistor size, (iii) at least one second capacitor (e.g., capacitors 930b and 932b) each having a second capacitance, and (iv) a second set of transistors (e.g., NMOS transistors 942b) coupled to the at least one second capacitor and having a second transistor size. In an exemplary design, the second capacitance may be twice the first capacitance, and the second transistor size may be twice the first transistor size. The first and second transistor sizes may be determined based on the first and second capacitances to obtain a target Q for the first and second capacitors.

In an exemplary design, the apparatus may further comprise a look-up table configured to store a plurality of settings for the at least one adjustable capacitor in the programmable directional coupler. The look-up table may receive an indication of a current operating scenario of the apparatus and may provide one of the plurality of settings corresponding to the current operating scenario for the at least one adjustable capacitor.

In an exemplary design, the apparatus may further comprise a directional coupler (e.g., directional coupler 752b in FIG. 7) coupled to the programmable directional coupler (e.g., programmable directional coupler 750 in FIG. 7). The apparatus may also comprise (i) a first power amplifier (e.g., power amplifier 740a) coupled to an input/first port of the programmable directional coupler and (ii) a second power amplifier coupled to an input/first port of the directional coupler. An isolated/fourth port of the directional coupler may be coupled to a coupled/third port of the programmable directional coupler. In general, the apparatus may comprise any number of fixed and/or programmable directional couplers coupled in cascade and any number of power amplifiers coupled to the input/first port of the directional couplers.

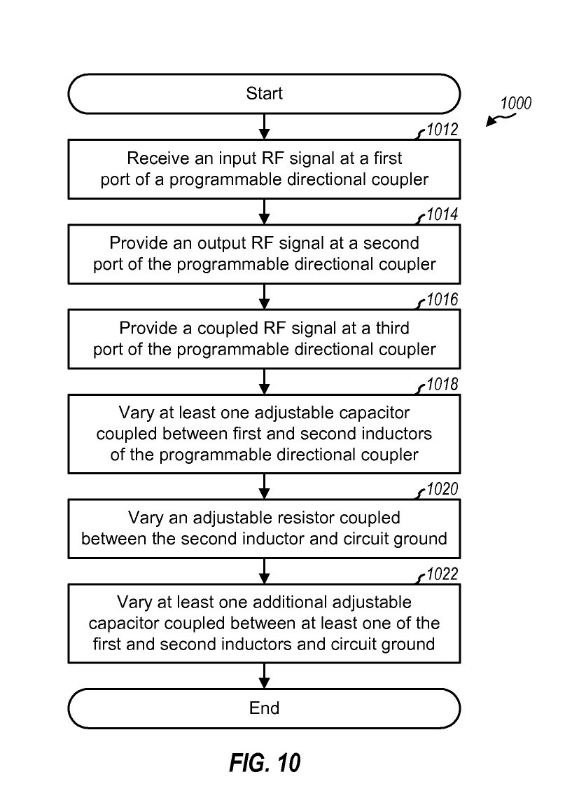

FIG. 10 shows an exemplary design of a process 1000 for performing directional coupling. An input RF signal may be received at a first port of a programmable directional coupler (block 1012). An output RF signal may be provided at a second port of the programmable directional coupler (block 1014). A coupled RF signal may be provided at a third port of the programmable directional coupler (block 1016). The programmable directional coupler may include a first inductor coupled between first and second nodes and a second inductor coupled between third and fourth nodes. The programmable directional coupler may also comprise first, second and third ports coupled to the first, second and third nodes, respectively. The programmable directional coupler may further comprise a fourth port coupled to the fourth node.

At least one adjustable capacitor (e.g., capacitor 534 and/or 536 in FIG. 5C) coupled between the first and second inductors of the programmable directional coupler may be varied (block 1018). An adjustable resistor (e.g., resistor 528 in FIG. 5C) coupled between the second inductor and circuit ground may also be varied (block 1020). At least one additional adjustable capacitor (e.g., capacitors 538 in FIG. 5C) coupled between at least one of the first and second inductors and circuit ground may also be varied (block 1022). Any one or any combination of blocks 1018, 1020 and 1022 may be performed.

A programmable directional coupler described herein may be implemented on an IC, an analog IC, an RFIC, a mixed-signal IC, an ASIC, a printed circuit board (PCB), an electronic device, etc. The programmable directional coupler may also be fabricated with various IC process technologies such as complementary metal oxide semiconductor (CMOS), N-channel MOS (NMOS), P-channel MOS (PMOS), bipolar junction transistor (BJT), bipolar-CMOS (BiCMOS), silicon germanium (SiGe), gallium arsenide (GaAs), heterojunction bipolar transistors (HBTs), high electron mobility transistors (HEMTs), silicon-on-insulator (SOI), etc.

An apparatus implementing a programmable directional coupler described herein may be a stand-alone device or may be part of a larger device. A device may be (i) a stand-alone IC, (ii) a set of one or more ICs that may include memory ICs for storing data and/or instructions, (iii) an RFIC such as an RF receiver (RFR) or an RF transmitter/receiver (RTR), (iv) an ASIC such as a mobile station modem (MSM), (v) a module that may be embedded within other devices, (vi) a receiver, cellular phone, wireless device, handset, or mobile unit, (vii) etc.

In one or more exemplary designs, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

The previous description of the disclosure is provided to enable any person skilled in the art to make or use the disclosure. Various modifications to the disclosure will be readily apparent to those skilled in the art, and the generic principles defined herein may be applied to other variations without departing from the scope of the disclosure. Thus, the disclosure is not intended to be limited to the examples and designs described herein but is to be accorded the widest scope consistent with the principles and novel features disclosed herein.

What is claimed is:

1. An apparatus comprising:
a first inductor coupled between a first node and a second node of a programmable directional coupler;
a second inductor coupled between a third node and a fourth node of the programmable directional coupler, the second inductor being magnetically coupled to the first inductor and having a mutual inductance with the first inductor; and
at least one adjustable capacitor coupled between the first and second inductors.

2. The apparatus of claim 1, further comprising:
a first port coupled to the first node and configured to receive an input radio frequency (RF) signal;
a second port coupled to the second node and configured to provide an output RF signal; and
a third port coupled to the third node and configured to provide a coupled RF signal.

3. The apparatus of claim 2, further comprising:
a fourth port coupled to the fourth node and configured to provide a reflected RF signal.

4. The apparatus of claim 1, the at least one adjustable capacitor comprising an adjustable capacitor coupled between the first and third nodes or between the second and fourth nodes.

5. The apparatus of claim 1, the at least one adjustable capacitor comprising:
a first adjustable capacitor coupled between the first and third nodes; and
a second adjustable capacitor coupled between the second and fourth nodes.

6. The apparatus of claim 1, further comprising:
at least one capacitor coupled between at least one node among the first, second, third and fourth nodes and circuit ground.

7. The apparatus of claim 1, further comprising:
at least one adjustable capacitor coupled between at least one node among the first, second, third and fourth nodes and circuit ground.

8. The apparatus of claim 1, further comprising:
an adjustable resistor coupled between the fourth node and circuit ground.

9. The apparatus of claim 1, further comprising:
a capacitor coupled between the second node and circuit ground, the first inductor and the capacitor forming an impedance matching circuit.

10. The apparatus of claim 1, wherein the first inductor has a first inductance, and wherein the second inductor has a second inductance different from the first inductance.

11. The apparatus of claim 1, wherein the first and second inductors are stacked on two layers of an integrated circuit or a circuit board or formed side-by-side on a single layer of the integrated circuit or the circuit board.

12. The apparatus of claim 1, one of the at least one adjustable capacitor comprising at least one switchable capacitor, each switchable capacitor being selected or unselected based on a respective control signal.

13. The apparatus of claim 1, one of the at least one adjustable capacitor comprising:
at least one first capacitor each having a first capacitance;
a first set of transistors coupled to the at least one first capacitor and having a first transistor size;
at least one second capacitor each having a second capacitance; and
a second set of transistors coupled to the at least one second capacitor and having a second transistor size.

14. The apparatus of claim 1, further comprising:
a look-up table configured to store a plurality of settings for the at least one adjustable capacitor, to receive an indication of a current operating scenario of the apparatus, and to provide one of the plurality of settings corresponding to the current operating scenario for the at least one adjustable capacitor.

15. The apparatus of claim 1, further comprising:
a directional coupler coupled to the programmable directional coupler.

16. The apparatus of claim 15, further comprising:
a first power amplifier coupled to an input port of the programmable directional coupler; and
a second power amplifier coupled to an input port of the directional coupler, and
wherein an isolated port of the directional coupler is coupled to a coupled port of the programmable directional coupler.

17. A method comprising:
receiving an input radio frequency (RF) signal at a first port of a programmable directional coupler;
providing an output RF signal at a second port of the programmable directional coupler;
providing a coupled RF signal at a third port of the programmable directional coupler; and
varying at least one adjustable capacitor coupled between first and second inductors of the programmable directional coupler.

18. The method of claim 17, further comprising:
varying an adjustable resistor coupled between the second inductor and circuit ground.

19. The method of claim 17, further comprising:
varying at least one additional adjustable capacitor coupled between at least one of the first and second inductors and circuit ground.

20. An apparatus comprising:
means for directional coupling an input radio frequency (RF) signal received at a first port to provide an output RF signal at a second port and to provide a coupled RF signal at a third port; and
means for varying the means for directional coupling.
